(19) United States
(12) Patent Application Publication
(10) Pub. No.: US 2025/0101322 A1
(43) Pub. Date: Mar. 27, 2025

(54) HEAT TREATMENT WITH ADSORPTION PURIFICATION OF ORGANIC MATERIAL OF BIOLOGICAL ORIGIN

(71) Applicant: Neste Oyj, Espoo (FI)

(72) Inventors: Thomas BJÖRKLÖF, Porvoo (FI); Petri LINDQVIST, Porvoo (FI)

(73) Assignee: Neste Oyj, Espoo (FI)

(21) Appl. No.: 18/725,392

(22) PCT Filed: Dec. 30, 2022
(86) PCT No.: PCT/FI2022/050886

§ 371 Date: Jun. 28, 2024

(30) Foreign Application Priority Data
Dec. 30, 2021 (FI) 20216371

(51) Int. Cl. C10G 69/02; C10G 7/00; C10G 25/05

(52) U.S. Cl. CPC C10G 69/02; C10G 7/00; C10G 25/05

(57) ABSTRACT

The present disclosure provides a method of purifying an organic material of biological origin, which includes providing a feedstock containing organic material of biological origin; purifying the feedstock in a pre-treatment step including heating the feedstock in a presence of an adsorbent at a temperature of at least 150° C., to obtain a heat-treated feedstock; filtering the heat-treated feedstock to remove adsorbent and to obtain a purified feedstock; and optionally subjecting the purified feedstock to further processing, wherein the purifying is performed in a cone vessel having a first cross sectional area in an upper part of the vessel which decreases downwards to a second cross sectional area, which is smaller than the first cross sectional area.

### FIELD OF THE INVENTION

The present invention relates to a method of purifying organic material of biological origin, especially organic material of biological origin, which can be converted to hydrocarbons suitable for base oil and fuel applications. In particular the invention relates to a method of purifying organic material comprising high amount of impurities, such as nitrogen, silicon, chloride and phosphorous compounds as well as metals. These organic materials are potential feedstock in hydrotreatment processes, but high amount of impurities limits their use.

### BACKGROUND OF THE INVENTION

Recycled and renewable organic material of biological origin are in many cases suitable as feedstock in processes to produce hydrocarbon material, such as base oils and fuels. However, many recycled or renewable organic material, otherwise suitable as feedstock, contains high amounts of silicon and phosphorous compounds. These and other impurities such as chlorine and metal, limits the suitability of many organic materials as feedstock in processes which involve hydrotreatment in the presence of highly sensible catalysts. The impurities therefore need to be effectively removed before catalytically processing the organic material. The impurities are known catalyst poisons and not removing them would seriously weaken the process and thus the product quality but also shorten the cycle lengths of both catalysts and equipment.

For example, crude tall oil including pitch is a suitable feedstock for production of hydrocarbons. Tall oil contains high amounts of silicon and phosphorous impurities, most likely originating from anti-fouling agents used in upstream processing. Anti-fouling agents comprise e.g. polydimethylsiloxanes (PDMS), which are soluble in oil and therefore difficult to remove. Other impurities in tall oil may originate from sand and dirt, which come from collection of the wood.

Conventional purification methods include bleaching and/or filtration, but these methods are not sufficient to remove e.g. silicon impurities effectively. Purification of organic material at high temperature in the presence of an adsorbent is suggested in WO 2020/016410.

However, more effective and economically sensible purification methods for organic material containing high amounts of impurities, mainly silicon and phosphorous compound, are still needed.

### BRIEF DESCRIPTION OF THE INVENTION

An object of the present invention is thus to provide a method so as to solve overcome the above problems. The objects of the invention are achieved by a method and an arrangement which are characterized by what is stated in the independent claims. The preferred embodiments of the invention are disclosed in the dependent claims.

The invention therefore presents a method of purifying an organic material of biological origin, the method comprising
a) providing a feedstock comprising organic material of biological origin,
b) purifying the feedstock in a pre-treatment step comprising heating the feedstock in the presence of an adsorbent at a temperature of at least 150° C., to obtain a heat-treated feedstock,
c) filtering the heat-treated feedstock to remove adsorbent and to obtain a purified feedstock, and
d) optionally subjecting the purified feedstock to further processing, wherein the purification in step b) is performed in a cone vessel, and the cone vessel has a first cross sectional area in an upper part of the vessel and the cross sectional area decreases downwards to a second cross sectional area, which is smaller than the first cross sectional area.

This invention provides a reactor configuration for purification of organic material that can facilitate sufficient mixing at high pressure. Additionally, the solids concentration gradient due to the fluidization and disengagement mitigates issues related to attrition of adsorbent and erosion and fouling.

### BRIEF DESCRIPTION OF THE DRAWINGS

In the following the invention will be described in greater detail by means of preferred embodiments with reference to the attached drawing, in which

FIG. 1 shows a schematic drawing of the reactor suitable for the current purification method, as described herein.

### DETAILED DESCRIPTION OF THE INVENTION

The present invention provides a method of purifying an organic material of biological origin.

As used herein the term “organic material of biological origin” refers to organic material, i.e. material containing carbon. The organic material is of biological origin, i.e. from natural resource such as but not limited to plants, trees, algae, microbes but also animal sources are possible. Organic material of biological origin is here meant to exclude fossil based organic material. The organic material suitable in the present process typically contain organic compounds such as fatty acids, resin and rosin acids and/or other lipophilic compounds but also other organic compounds.

Particular examples of the feedstock comprising organic material of biological origin of the present invention include, but are not limited to, animal based fats and oils, such as suet, tallow, blubber, lard, train oil, milk fat, fish oil, fish fat, poultry oil, and poultry fat; plant based fats and oils, such as sludge palm oil, rapeseed oil, canola oil, colza oil, sunflower oil, soybean oil, hemp oil, olive oil, linseed oil, cottonseed oil, mustard oil, mustard, seed oil, palm oil, palm kernel oil, palm seed oil, arachis oil, castor oil, coconut oil, peanut oil, corn oil, babassu oil, muscat butter oil, sesame oil, maize oil, poppy seed oil, soy oil, laurel seed oil, jatropha oil, palm kernel oil, camelina oil, lignocellulosic pyrolysis liquid (LPL), HTL biocrude, crude tall oil (CTO), tall oil pitch (TOP), crude fatty acid (CFA), tall oil fatty acid (TOFA) and distilled tall oil (DTO); microbial oils; algal oils; archaeal oil; bacterial oil; fungal oil; protozoal oil; seaweed oil; recycled fats or various waste streams of the food industry, such as used cooking oil, yellow and brown greases; free fatty acids, any lipids containing phosphorous and/or metals, oils originating from yeast or mold products, recycled alimentary fats; starting materials produced by genetic engineering, and any mixtures of said feedstocks.

In one embodiment of the current invention the feedstock comprising organic material of biological origin comprise pitch containing crude tall oil (CTO), residue and waste oils from palm oil production and/or recycled fats and oils.

In an embodiment of the present invention organic material of biological origin used as feedstock is selected from a group consisting of crude tall oil (CTO), tall oil pitch (TOP), tall oil fatty acid (TOFA), crude fatty acid (CFA), and distilled tall oil (DTO); more particularly the organic material of biological origin is crude tall oil (CTO) or tall oil pitch (TOP).

In addition or as an alternative, the organic material of biological origin can also be selected from acid oils, such as acidulated soapstock (ASK), technical corn oil (TCO), plant oil from plants of the family Brassicaceae (carinata oil), palm effluent sludge (PES), used cooking oil (UCO), gutter oil and brown grease (BG).

As defined herein crude tall oil (CTO, CAS Registry Number 8002-26-4) is most frequently obtained as a by-product of either Kraft or Sulphite pulping processes and tall oil pitch (TOP, CAS number of 8016-81-7) is the residual bottom fraction from crude tall oil distillation processes.

Crude tall oil comprises resin acids, fatty acids, and unsaponifiables.

Resin acids are a mixture of organic acids derived from oxidation and polymerization reactions of terpenes. The main resin acid in crude tall oil is abietic acid but abietic derivatives and other acids, such as pimaric acid are also found. Fatty acids are long chain monocarboxylic acids and are found in hardwoods and softwoods. The main fatty acids in crude tall oil are oleic, linoleic and palmitic acids. Unsaponifiables cannot be turned into soaps as they are neutral compounds which do not react with sodium hydroxide to form salts. They include sterols, higher alcohols and hydrocarbons. Sterols are steroids derivatives which also include a hydroxyl group.

Tall oil pitch (TOP) can be considered to be a UVCB substance (Substances of Unknown or Variable composition, Complex reaction product or Biological materials) under the REACH definition (ECHA; Guidance in a Nutshell, Identification and naming of substances under REACH and CLP; Version 2.0, April 2017). Composition of TOP according to Holmbom (1978) is presented in Table 1, wherein A, B, C, D denote ordinary grades of tall oil pitch received from three plants in Finland and E and F denote US grades investigated.

Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic and other resin acids. The esterified acids are typically selected from a group consisting of oleic and linoleic acids. The unsaponifiables neutral compounds are typically selected from a group consisting of diterpene sterols, fatty alcohols, sterols, and dehydrated sterols.

The term “crude fatty acid (CFA)” refers to fatty acid-containing materials obtainable by purification (e.g., distillation under reduced pressure, extraction, and/or crystallization) of CTO. The term “tall oil fatty acid (TOFA)” refers to fatty acid rich fraction of crude tall oil (CTO) distillation processes. TOFA typically comprises mainly fatty acids, typically at least 80 wt. % of the total weight of the TOFA. Typically, TOFA comprises less than 10 wt. % rosin acids.

TABLE 1
Component Group Composition of Tall Oil Pitch (wt. % of pitch)^{a}

| Constituents | A | B | C | D | E | F |
|---|---|---|---|---|---|---|
| Free acids, total | 39.3 | 52.6 | 48.6 | 44.6 | 46.7 | 34.6 |
| Fatty acids | 1.4 | 1.8 | 1.3 | 0.8 | 1.3 | 2.4 |
| Resin acids | 10.6 | 12.5 | 9.7 | 6.1 | 3.3 | 6.5 |
| Other acids | 27.3 | 37.3 | 37.3 | 37.7 | 42.1 | 25.7 |
| Esterified acids, total | 30.6 | 23.2 | 23.3 | 26.8 | 27.9 | 37.8 |
| Fatty acids | 8.2 | 12.9 | 13.3 | 15.2 | 13.8 | 12.4 |
| Resin acids | 1.7 | 0.9 | 1.2 | 0.9 | 1.6 | 1.9 |
| Other acids | 20.7 | 9.4 | 8.8 | 10.7 | 12.5 | 23.5 |
| Equiv. weight for free | 648 | 591 | 716 | 642 | 873 | 719 |
| acids | | | | | | |

^{a}Holmbom B, and Erä V, 1978. Composition of Tall oil pitch, Journal of the American oil chemistry society, 55, pp. 342-344.

The term “distilled tall oil (DTO)” refers to resin acid rich fraction of crude tall oil (CTO) distillation processes. DTO typically comprises mainly fatty acids, typically from 55 to 90 wt. %, and rosin acids, typically from 10 to 40 wt. % rosin acids, of the total weight of the DTO. Typically, DTO comprises less than 10 wt. % unsaponifiable neutral compounds of the total weight of the distilled tall oil.

Acid oils refers to by-products of alkali or physical refining of crude oils and fats. One example of acid oils are oils obtained by acidulation of soapstock (ASK), which contains free fatty acids, acylglycerols and other lipophilic compounds.

The term “technical corn oil” TCO refers to corn oil extracted through a dry milling process. In the dry milling process, corn grains are cleaned and ground directly to obtain a fine corn flour. This flour is then mixed with water, enzymes and other ingredients (cooking and liquefaction) to convert starch into simple sugars, then into glucose (saccharification). This glucose is fermented to produce ethanol, which is then removed by distillation and purified by dehydration. The remaining stillage (called distillers grain) is then processed further to expel technical corn oil (generally called “distillers corn oil” in the United States) through centrifugation. De-emulsifiers can be used to enhance separation of the TCO from the rest of the stillage.

The organic material can also comprise plant oil originating from a plant of the family Brassicaceae (carinata oil). The plant of the family Brassicaceae is selected from Brassica juncea (brown mustard), Brassica carinata (Ethiopian mustard), Brassica nigra (black mustard), Brassica rapa, Brassica rapa subsp. oleifera (field mustard), Brassica elongate (elongated mustard), Brassica nariosa (broadbaked mustard), Brassica rupestris (brown mustard), Brassica tournefortii (Asian mustard), Brassica napus, Brassica napus el, Sinapis hirta (mustard), Sinapis alba (white mustard), Sinapis arvensis, Nasturtium floridanum, Nasturtium gambellium, Nasturtium gronlandicum, Nasturtium microfullum, nasturtium officinale, Nasturtium sordidum and combinations thereof. Preferably the plant is Brassica carinata.

The term “palm effluent sludge” (PES), also commonly referred to, as palm oil mill effluent (POME) here refers to the voluminous liquid waste that comes from the sterilisation and clarification processes in milling oil palm. The raw effluent contains 90-95% water and includes residual oil, soil particles and suspended solids.

The term “used cooking oil” (UCO) refers to oils and fats that have been used for cooking or frying in the food processing industry, restaurants, fast foods and at consumer level, in households.

Gutter oil is a general term for oil that has been recycled. It can be used to describe the practice of restaurants re-using cooking oil that has already been fried before.

Brown grease (BG) means an emulsion of fat, oil, grease, solids, and water separated from wastewater in a grease interceptor (grease trap) and collected for use as feedstock.

In one embodiment the organic material of biological origin comprises crude tall oil (CTO) optionally including tall oil pitch (TOP), tall oil pitch (TOP), brown grease (BG), acidulated soapstock (ASK), technical corn oil (TCO), low quality animal fat (AF), Brassica carinata (BC), palm effluent sludge (PES) or any combination thereof. In one embodiment the feedstock comprises crude tall oil (CTO), tall oil pitch (TOP), brown grease (BG) and acidulated soapstock (ASK).

The present method comprises purifying the feedstock in a pre-treatment step comprising heating the feedstock in the presence of an adsorbent at a temperature of at least 150° C., to obtain a heat-treated feedstock, wherein the purification in step is performed in a cone vessel, wherein the cone vessel has a first cross sectional area in an upper part of the vessel and the cross sectional area decreases downwards to a second cross sectional area, which is smaller than the first cross sectional area.

In one embodiment the feedstock to be purified is introduced to the bottom section of the cone vessel, the heat-treated feedstock is withdrawn at a mid-section of the cone vessel. The cone vessel can in addition comprise a loop for recycling the feedstock in the cone vessel. The recycling loop withdraws a stream from a top section of the cone vessel and re-introduces the recycled feedstock to a bottom section of the cone vessel. The recycling loop can optionally also comprise a separate heater to heat the recycled feedstock.

In one embodiment the adsorbent is introduced as a side-stream to the feedstock inlet or directly to the cone vessel using a separate inlet. The adsorbent can be selected from silico-based adsorbents, preferably from a group consisting of alumina silicate, silica gel and mixtures thereof.

In one embodiment the purification step is performed at a temperature from 180° C. to 325° C., preferably from 200° C. to 300° C., more preferably from 240° C. to 280° C. The pressure in the purification step can be at least 30 bar, such as from 30 to 60 bar, preferably from 40 to 50 bar.

The wide upper section of the cone reactor functions as a disengagement zone, enabling the solid particles to separate through gravity, due to lower linear velocity. This creates a solids concentration gradient in the reactor with less solids present in the upper part, from which the circulation is pumped. This has the benefit of preventing attrition, erosion and/or fouling in the circulation loop. When the cone reactor comprises a loop. The cone reactor can have a configuration for adsorption at high temperatures and pressures, with a pump around from the top of the reactor to the conically shaped bottom to facilitate mixing. The recirculation can be injected at a sufficiently high linear velocity to effectively fluidize the solid adsorbent in the lower part of the reactor. The fluidization provides adequate mixing and contact between feedstock and adsorbent.

The purification step is followed by filtering the heat-treated feedstock to remove adsorbent and to obtain a purified feedstock.

The current method can also comprise further pre-treatment or purification steps. The further pre-treatment step can be selected from evaporations steps, degumming, bleaching and any combination thereof.

The purified feedstock can also be subjected to further processing. The further processing can comprise
subjecting said purified feedstock to pre-hydrotreatment to obtain a stream of partly hydrotreated feed,
subjecting the partly hydrotreated feed to hydrotreatment to obtain a stream of hydrocarbons, and
subjecting the stream of hydrocarbons to isomerization to obtain an isomerised stream of hydrocarbons.

The pre-hydrotreatment can be performed in conditions selected from:
a temperature range of 300° C. to 380° C., preferably of 320° C. to 360° C.;
a pressure range of 40 to 100 bar, preferably 40 to 80 bar, more preferably 50 to 70 bar;
a weight hourly space velocity (WHSV) of 0.2 l/h to 10 l/h, preferably 0.25 l/h to 10 l/h, preferably 0.3 l/h to 8 l/h; and
a H₂/oil feed of 800 dm³/dm³ to 1200 dm³/dm³, preferably of 900 dm³/dm³ to 1100 dm³/dm³.

The catalyst used in the pre-hydrotreatment step is a typical hydrotreating catalyst such as Ni, Co, Mo, W or any combination thereof on a carrier such as alumina. Alternatively or in addition the catalyst in pre-hydrotreatment can also be a typically hydrocracking catalyst such as NiW on acidic supports (ASA, Zeolites). In one embodiment the catalyst in the pre-hydrotreatment is NiMo on alumina carrier. The pre-treatment step is typically carried out in a reactor with one or more catalyst beds. The extent of the pre-hydrotreatment depends on the organic material and level of impurities. The aim of the pre-treatment is to prepare the feed, e.g. to remove heteroatoms and other impurities, to such a level that the hydrotreatment can remove the rest of the heteroatoms and impurities prior to the isomerization.

The pre-hydrotreatment step is meant to remove a major part of the heteroatoms and those other impurities still left after the pre-treatment. In one embodiment of the present invention the amount of nitrogen can be removed by at least 80 wt. %, oxygen by at least 90 wt. % and phosphorous by at least 95 wt. % in the partly hydrotreated feed. These high levels of removal of heteroatoms and impurities shows that major part of the removal takes place in pre-hydrotreatment compared to the hydrotreatment step. Thereby, more adverse effect, such as formation of water and ammonia and catalyst de-activation, takes place in the prehydrotreatment step. The catalyst in the pre-hydrotreatment can be changed frequently, while the catalyst in the hydrotreatment step stays fresh. Also, fresh hydrogen can be introduced to the hydrotreatment step, which enable highly efficient conversion. Since major part of the conversion takes place in pre-hydrotreatment, the hydrotreatment step can be controlled such that the hydrotreated product is of high quality.

In the pre-hydrotreatment the partly hydrotreated feed withdrawn from the reactor, can be recycled in a relatively high ratio. The ratio of recycled partly hydrotreated feed to fresh purified feedstock in the pre-hydrotreatment step can be from 1:1 to 15:1, preferably 1:1 to 10:1 and more preferably 1:1 to 5:1.

The hydrotreatment can be performed in conditions selected from:
a temperature range of 300° C. to 380° C., preferably of 320° C. to 360° C.;
a pressure range of 40 to 80 bar, preferably 50 to 70 bar;
a weight hourly space velocity (WHSV) of 0.25 l/h to 1.5 l/h, preferably 0.3 l/h to 1 l/h; and
a H₂/oil feed of 800 dm³/dm³ to 1200 dm³/dm³, preferably of 900 dm³/dm³ to 1100 dm³/dm³.

The catalyst used in the hydrotreatment step is a typical hydrotreating catalyst such as Ni, Co, Mo, W or any combination thereof on a carrier such as alumina. Alternatively or in addition, the catalyst in the hydrotreatment can also be a typically hydrocracking catalyst such as NiW on acidic supports (ASA, Zeolites). In one embodiment the catalyst in the hydrotreatment is NiMo on alumina carrier. The treatment step is typically carried out in a reactor with one or more catalyst beds.

In the hydrotreatment the stream of hydrocarbon withdrawn from the reactor can be recycled back to the hydrotreatment. If there is recycling in the hydrotreatment step, the amount of recycled material is very low. In an embodiment a maximum of 10 wt. % of the stream of hydrocarbons is recycled back to hydrotreatment. In one embodiment the hydrotreatment step does not contain any recycling.

The aim of the hydrotreatment is to essentially remove all impurities and heteroatoms from the feed, and the stream of hydrocarbons should therefore essentially only contain hydrocarbons.

In one embodiment of the current invention, the isomerization of the stream of hydrocarbons to obtain a stream of isomerized hydrocarbons is performed in conditions selected from:
a temperature range of 300° C. to 360° C., preferably 310° C. to 345° C.;
a pressure range of 35 bar to 60 bar, preferably 40 bar to 50 bar;
a weight hourly space velocity (WHSV) of 1 l/h to 1.5 l/h.

The catalyst used in the isomerization of the stream of hydrocarbons is any typical isomerization catalyst, such as Pt or Pd on a suitable support, preferably the isomerization catalyst is Pt-SAPO11.

The further processing can also comprise distilling at least one stream of the process to obtain at least two fractions, a first heavy bottom fraction, which can be removed from the process and a second middle fraction, which can be collected for further treatment. Alternatively, the first heavy bottom fraction is collected, and the second middle fraction is removed from the process.

The first heavy bottom fraction can be characterized such that at least 90% of the components (compounds) of the first heavy bottom fraction have a boiling point of 360° C. or above. The second middle fraction can be characterized such that at least 90% of the components (compounds) of the second middle fraction have a boiling point of from 180° C. to 360° C. All boiling points are given in atmospheric pressure. The first heavy bottom fraction can be used as a product as such or subjected to other processes (not disclosed here).

In one embodiment of the present invention the distillation is performed using the following conditions: a cut point target of 340° C. to 360° C., vacuum set point of 2 mbar, top column temperature of 180° C., nitrogen feed rate of 2 l/h and feed rate of 0.24 l/h. These conditions are to be regarded as examples and a skilled person is able to operate the distillation such that the target fractions are obtained.

In one embodiment of the present invention the process further comprises a stripping step to remove gaseous compounds from a stream of the process. The stripping step can be performed after the pre-treatment step, the pre-hydrotreatment step, the hydrotreatment step, the isomerization step or any combination thereof. In one embodiment the stripping is performed after the pre-hydrotreatment step to remove gaseous compounds before the distillation step. Gaseous compounds which can be removed in a stripping step include sulphide (H₂S), ammonia (NH₃) and water. The stripping step can also be called a flash step or flash evaporation or flash distillation.

In the process of the present invention said feedstock comprising organic material of biological origin has prior to the pre-treatment step preferably not been distilled or evaporated, such that the gaseous fraction is collected for further processing steps and residue or liquid fraction is discarded.

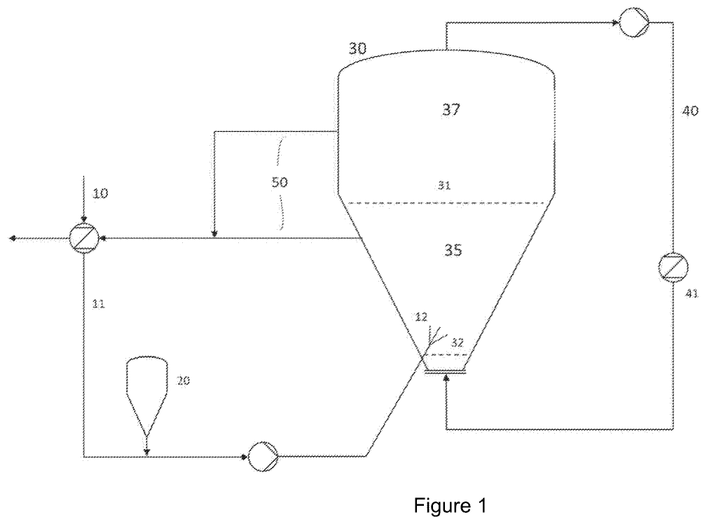

FIG. 1 depicts a schematic drawing of a cone reactor according to the invention. In the FIGURE it is shown how a feed comprising organic material of biological material can be pre-heated to provide a pre-heated feed [11]. Adsorbent [20] according to the invention is then added to the pre-heated feed and then introduced to the cone reactor [30]. The inlet for feed and adsorbent [20] is introduced at the bottom of the cone reactor [30]. The cone reactor can generally be divided in two separate zone, a fluidization zone and a disengagement zone [37]. The cone reactor has a first cross sectional area in an upper part of the vessel and a second cross sectional area [32]. The area of the second cross sectional area is smaller than the first cross sectional area [31]. The cone reactor also comprises a recycling loop for recycling feedstock. The recycling loop also contains a heater for the recycled feedstock. Product [50], which is treated in the cone reactor is withdrawn and cooled. The product is then filtered (not shown in FIG. 1) to get rid of adsorbent and impurities.

It will be obvious to a person skilled in the art that, as the technology advances, the inventive concept can be implemented in various ways. The invention and its embodiments are not limited to the examples described above but may vary within the scope of the claims.

1.-8. (canceled)

9. A method of purifying an organic material of biological origin, the method comprising:
a) providing a feedstock containing organic material of biological origin;
b) purifying the feedstock in a pre-treatment step including heating the feedstock in a presence of an adsorbent at a temperature of at least 150° C., to obtain a heat-treated feedstock;
c) filtering the heat-treated feedstock to remove adsorbent and to obtain a purified feedstock; and
d) optionally subjecting the purified feedstock to further processing,
wherein the purifying in step b) is performed in a cone vessel, and the cone vessel has a first cross sectional area in an upper part of the vessel and the cross sectional area decreases downwards to a second cross sectional area, which is smaller than the first cross sectional area.

10. The method of claim 9, wherein the feedstock to be purified is introduced to the bottom section of the cone vessel, and the heat-treated feedstock is withdrawn at a mid-section of the cone vessel.

11. The method of claim 9, wherein the cone vessel comprises:
a loop for recycling the feedstock in the cone vessel, and the recycling loop withdraws a stream from a top section of the cone vessel as a recycled feedstock and re-introduces the recycled feedstock to a bottom section of the cone vessel, and optionally the recycling loop includes a separate heater to heat the recycled feedstock.

12. The method of claim 9, wherein the adsorbent is introduced as a side-stream to the feedstock inlet or directly to the cone vessel using a separate inlet.

13. The method of claim 9, wherein the purifying step b) is performed at a temperature from 180° C. to 325° C., and/or from 200° C. to 300° C., and/or from 240° C. to 280° C.

14. The method of claim 9, wherein the adsorbent is selected from silico-based adsorbents, and/or from a group consisting of alumina silicate, silica gel and mixtures thereof.

15. The method of claim 9, wherein the purified feedstock is subjected to further processing, the further processing comprising:
subjecting said purified feedstock to pre-hydrotreatment to obtain a stream of partly hydrotreated feed;
subjecting the partly hydrotreated feed to hydrotreatment to obtain a stream of hydrocarbons; and
subjecting the stream of hydrocarbons to isomerization to obtain an isomerised stream of hydrocarbons.

16. The method according to claim 15, wherein the further processing comprises:
distilling at least one stream of the process to obtain at least two fractions, a first heavy bottom fraction which is removed from the process, and a second middle fraction which is collected for further treatment.

17. The method of claim 10, wherein the cone vessel comprises:
a loop for recycling the feedstock in the cone vessel, and the recycling loop withdraws a stream from a top section of the cone vessel as a recycled feedstock and re-introduces the recycled feedstock to a bottom section of the cone vessel, and optionally the recycling loop includes a separate heater to heat the recycled feedstock.

18. The method of claim 17, wherein the adsorbent is introduced as a side-stream to the feedstock inlet or directly to the cone vessel using a separate inlet.

19. The method of claim 18, wherein the purifying step b) is performed at a temperature from 180° C. to 325° C., and/or from 200° C. to 300° C., and/or from 240° C. to 280° C.

20. The method of claim 19, wherein the adsorbent is selected from silico-based adsorbents, and/or from a group consisting of alumina silicate, silica gel and mixtures thereof.

21. The method of claim 20, wherein the purified feedstock is subjected to further processing, the further processing comprising:
subjecting said purified feedstock to pre-hydrotreatment to obtain a stream of partly hydrotreated feed;
subjecting the partly hydrotreated feed to hydrotreatment to obtain a stream of hydrocarbons; and
subjecting the stream of hydrocarbons to isomerization to obtain an isomerised stream of hydrocarbons.

22. The method according to claim 21, wherein the further processing comprises:
distilling at least one stream of the process to obtain at least two fractions, a first heavy bottom fraction which is removed from the process, and a second middle fraction which is collected for further treatment.
